(19) United States
(12) Patent Application Publication
(10) Pub. No.: US 2010/0251258 A1
(43) Pub. Date: Sep. 30, 2010

(54) RECORDING MEDIUM HAVING LOAD BALANCING PROGRAM RECORDED THEREON, LOAD BALANCING APPARATUS AND METHOD THEREOF

(75) Inventors: Toshiya HANAMORI, Kawasaki (JP); Nobuo Shiba, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/732,557

(22) Filed: Mar. 26, 2010

(30) Foreign Application Priority Data
Mar. 31, 2009 (JP) 2009-86476

(51) Int. Cl. G06F 9/46; G06F 15/173

(52) U.S. Cl. 718/105; 709/223

(57) ABSTRACT

A load balancing method for servers including allocating a job to one or more servers, respectively, having a load lower that a first reference value, upon detection of a first server having a load that is higher that the first reference value and is lower that a second reference value, reducing a load of a second server having the lowest load among the servers by a load balancing, and upon detection of any server having a load that is higher that the second reference value, reallocating a job of the any server to another server having the lowest load among the servers.

### CROSS-REFERENCE TO RELATED APPLICATIONS

This application is based upon and claims the benefit of priority of the prior Japanese Patent Application No. 2009-86476, filed on Mar. 31, 2009, the entire contents of which are incorporated herein by reference.

### BACKGROUND

1. Field

Embodiments described herein relate to load balancing, more specifically to an apparatus and a technique performing load balancing of jobs of a batch process among a plurality of servers.

2. Description of the Related Art

In a computer system for performing a process of a business application, a batch process is generally performed in which data collected during a certain period of time is collectively processed. In a batch process, a large amount of data is processed and thus a high load tends to be imposed on a central processing unit (CPU), a memory, and input/output ports (I/O) of a server that processes the data. Also, a long time is often required to complete the process. For these reasons, it is difficult to execute a batch process in parallel with an online process, and the batch process is typically executed at night when no online process is performed. Such a batch process is executed in a case of, for example, performing a process of collectively creating forms at night to be delivered the next day on the basis of order data that was processed during the day.

Typically, a batch process is required to be reliably completed by a certain time the next day due to a business schedule or the like. In recent years, the speed at which business is conducted has been significantly increasing, which has resulted in situations where it is necessary to immediately use, before the day is over, data or the like on which a batch process is performed. Accordingly, the use of systems that apply a form of sequential execution of a batch process in parallel with an online process (on-demand batch) has been increasing.

In response to such a demand of business, a technique of performing load balancing has become widely used. In load balancing, a plurality of servers that execute jobs of a batch process are provided and the jobs are distributed thereto so that the servers stably operate and reliably complete the batch process by a certain time. In typical load balancing, when an execution request of a new job is received, the job is distributed to a server having a low load among a plurality of servers. However, since a job of a batch process often requires a long time as described above, the load of a server may increase during execution of the job and the process may be delayed even if the job is distributed on the basis of a temporary load status of the servers at the time of the initial distribution. Thus, there is used a technique of monitoring load statuses of servers during execution of jobs after the jobs have been distributed to the servers and performing redistribution of a job to another server when the load of any of the servers increases (e.g., Japanese Unexamined Patent Application Publication Nos. 2004-280457, 11-312149, and 05-120243).

However, such distribution has at least the following problems. That is, in a case where a load imposed on a server by executing a job to be redistributed is high, if the job is redistributed to another server, execution of a process may also be difficult in the server serving as the redistribution target. In this case, the job needs to be further redistributed from the server serving as the redistribution target to another server. Furthermore, as a result of repetition of redistribution among servers, a redistribution loop can occur in which the job eventually returns to the server that was executing the job first. In order to avoid such a situation, the following technique has been further suggested. That is, when there is a process to be redistributed in the future in an operation environment where a plurality of processors perform parallel processing, the process is not further distributed to a processor close to a processor that is executing a process, so as to acquire free space.

However, even if further distribution of a process (job) to a processor (server) serving as a redistribution target is prevented in this manner, sufficient free space may not be acquired if the server serving as the redistribution target already has had a predetermined load or more. This possibility is particularly high when a load required for a process of the job to be redistributed is high. In this case, redistribution is unsuccessfully performed again. Also, even at the time of initial distribution, if a load of a server serving as a distribution target of a job is high to some extent or more, an overload state occurs soon after the job is distributed, resulting in a situation requiring redistribution.

Once a load balance is lost, time is required to recover a balanced state. Accordingly, a stable operation of servers among which load balancing is performed is not realized, which causes a delay of a batch process.

### SUMMARY

According to an aspect of the invention, a load balancing method for servers that includes: allocating a job to one or more servers, respectively, having a load lower that a first reference value, upon detection of a first server having a load that is higher that the first reference value and is lower that a second reference value, reducing a load of a second server having the lowest load among the servers by a load balancing; and upon detection of any server having a load that is higher that the second reference value, reallocating a job of the any server to another server having the lowest load among the servers.

The aspect and advantages of the invention will be realized and attained by means of the elements and combinations particularly pointed out in the claims.

It is to be understood that both the foregoing general description and the following detailed description are exemplary and explanatory and are not restrictive of the invention, as claimed.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 illustrates a configuration of a load balancing system;

FIG. 2 illustrates a job table;

FIG. 3 illustrates a load status table;

FIG. 4 illustrates a distribution reference table;

FIG. 5 illustrates a standby-job table;

FIG. 6 is a flowchart illustrating a process performed by a distribution control unit upon receipt of a job execution request;

FIG. 7 is a flowchart illustrating a process performed by a load monitoring unit;

FIG. 8 is a first flowchart illustrating a process performed by a distribution control unit during load monitoring;

FIG. 9 is a second flowchart illustrating a process performed by a distribution control unit during load monitoring;

FIG. 10A illustrates a state before an initial distribution (first stage);

FIG. 10B illustrates a state before the initial distribution (second stage);

FIG. 10C illustrates a state after the initial distribution (second stage);

FIG. 11A illustrates a state after adjustment (third stage);

FIG. 11B illustrates a state after redistribution (fourth stage);

FIG. 12A illustrates a state before initial distribution (first stage);

FIG. 12B illustrates a state before the initial distribution (second stage);

FIG. 12C illustrates a state before adjustment (third stage);

FIG. 12D illustrates a state before redistribution (fourth stage);

FIG. 13 illustrates transfer of jobs in a specific example of load balancing (third stage); and

FIG. 14 illustrates transfer of a job in a specific example of load balancing (fourth stage).

### DETAILED DESCRIPTION

Reference will now be made in detail to the embodiments, examples of which are illustrated in the accompanying drawings, wherein like reference numerals refer to the like elements throughout. The embodiments are described below to explain the present invention by referring to the figures.

Embodiments will be described with reference to the drawings. According to an embodiment, a system executes the following process. A computer monitors load statuses of a plurality of servers, which are connected to a network, at predetermined time intervals. Also, upon receipt of an execution request of jobs of a batch process, the computer distributes jobs associated with the execution request only to one or more of the plurality of servers in which a load is lower than an initial distribution reference value, which indicates a level of load for which distribution of a job is allowed, on the basis of the monitored load statuses of the plurality of servers. Furthermore, if a load of any one of the plurality of servers is higher than at least the initial distribution reference value and is lower than a redistribution reference value, which indicates a level of load for which a job being executed in a server is necessary to be redistributed to another server, the computer specifies a server having a lowest load among the plurality of servers except the one of the plurality of servers, the specified server serving as a redistribution target of a job. Accordingly, the computer adjusts distribution of the jobs so that the load of the server serving as the redistribution target decreases to lower than a current load. Also, if the load of any one of the plurality of servers is higher than the redistribution reference value, the computer redistributes a job being executed in the one of the plurality of servers to another server.

According to an embodiment of a system, load statuses of servers are monitored at predetermined time intervals, and distribution of jobs is adjusted in accordance with levels of loads of the respective servers determined on the basis of a certain reference that is set stepwise (incrementally). That is, when a new job is to be distributed, the job is prevented from being distributed to a server having a load of a certain reference or more, so that the occurrence of a server requiring redistribution can be prevented. Also, when the load of a specific server increases over the certain reference during monitoring of load statuses, distribution of jobs is adjusted so that the load of a server serving as a redistribution target becomes lower than a current load. Therefore, the probability of success in redistribution can be reliably increased, and redistribution can be smoothly performed. Accordingly, a stable operation of individual servers is realized, and execution delay of a batch process due to an overload state of a server can be prevented in the whole system.

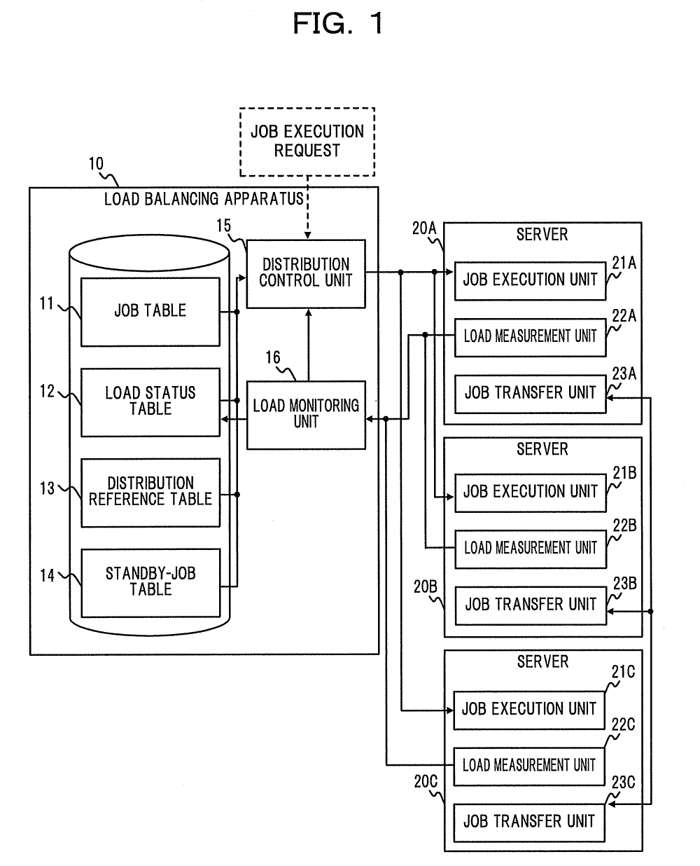

FIG. 1 illustrates an entire configuration of an example of a load balancing system. This system includes a load balancing apparatus 10 and servers 20A, 20B and 20C. Each of the load balancing apparatus 10 and the servers 20A, 20B and 20C may be a computer that includes at least a central processing unit (CPU) and a storage device. The load balancing apparatus 10 and the servers 20A, 20B and 20C are mutually connected via a network. As the network, a local area network (LAN), a wide area network (WAN), or the like is typically used, but the type of network is not specified as long as data can be transmitted/received between the load balancing apparatus 10 and the servers 20A, 20B and 20C. This system includes three servers, but the number of servers is not limited to three.

Upon receipt of an execution request of jobs through an operation performed by a system administrator or the like or a program, the load balancing apparatus 10 determines appropriate servers serving as distribution targets of the jobs in accordance with the load statuses of the servers 20A, 20B and 20C and performs an initial distribution process of transmitting execution requests of the jobs. On the other hand, the load balancing apparatus 10 receives notifications about load statuses (hereinafter load status notifications) from the servers 20A, 20B and 20C at predetermined time intervals to monitor the load statuses of the respective servers. Then, when receiving load status notifications from the respective servers, the load balancing apparatus 10 performs redistribution for transferring a job that is being executed in one of the servers to another as necessary.

The servers 20A, 20B and 20C execute jobs distributed by the load balancing apparatus 10, while notify the load balancing apparatus 10 of the load statuses of the own apparatuses at predetermined time intervals.

Now, a description will be given about jobs processed in this system, according to an embodiment. In this system, load balancing of jobs of a batch process is performed. Each job is composed of one or a plurality of operations (the unit of process). An execution request of a job is attached with characteristics of the job associated with the execution request, that is, an execution time of the job and load characteristics serving as indexes indicating a usage frequency (level of load) of load items (e.g., CPU, memory, and I/O) serving as load factors of a server during a process of the job. Note that those characteristics are only examples of characteristics of a job and are referred to herein in an exemplary manner.

Next, a configuration of the load balancing apparatus 10 will be described.

The load balancing apparatus 10 includes a storage device, such as a memory or a hard disk drive (HDD), which holds a job table 11, a load status table 12, a distribution reference table 13, and a standby-job table 14. In the load balancing apparatus 10, a load balancing program is executed by a CPU, which cooperates with hardware devices, such as the storage device, an input device, and a port for realizing communication, whereby a distribution control unit 15 and a load monitoring unit 16 are realized. The load balancing program can be recorded on a computer-readable recording medium, such as a magnetic tape, a magnetic disk, a magnetic drum, an IC card, a compact disc read only memory (CD-ROM), or a digital versatile disc read only memory (DVD-ROM). Installing the load balancing program recorded on the recording medium to the load balancing apparatus 10 enables execution of the load balancing program.

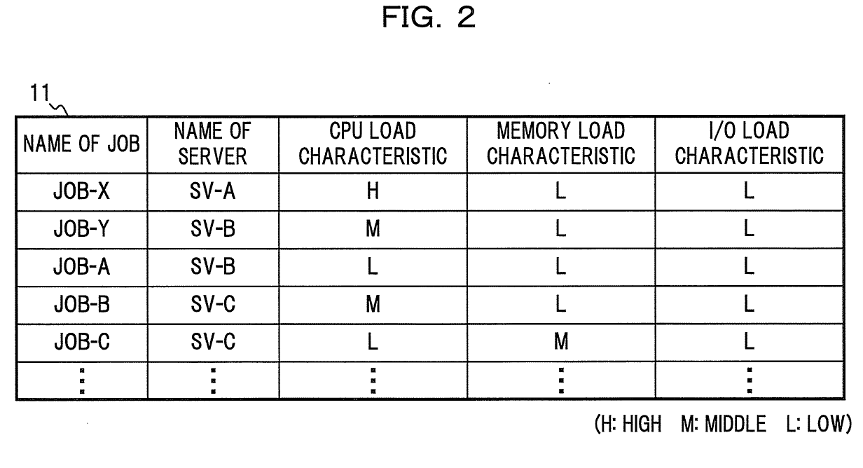

The job table 11 is a table for recording information including of servers in which jobs are being executed and characteristics of the jobs, and includes the name of job, the name of server in which a job is being executed, and load characteristics of respective load items (CPU, memory, and I/O), as illustrated in FIG. 2. As load characteristics of the respective load items, “H” is set when the load of a load item is high, “M” is set when the load of a load item is middle, and “L” is set when the load of a load item is low.

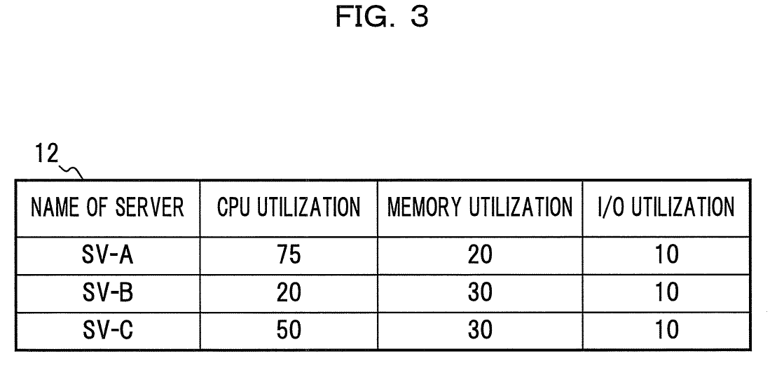

The load status table 12 is a table for recording load statuses of the respective servers, and includes the name of server, and the CPU utilization, memory utilization, and I/O utilization in each server, as illustrated in FIG. 3.

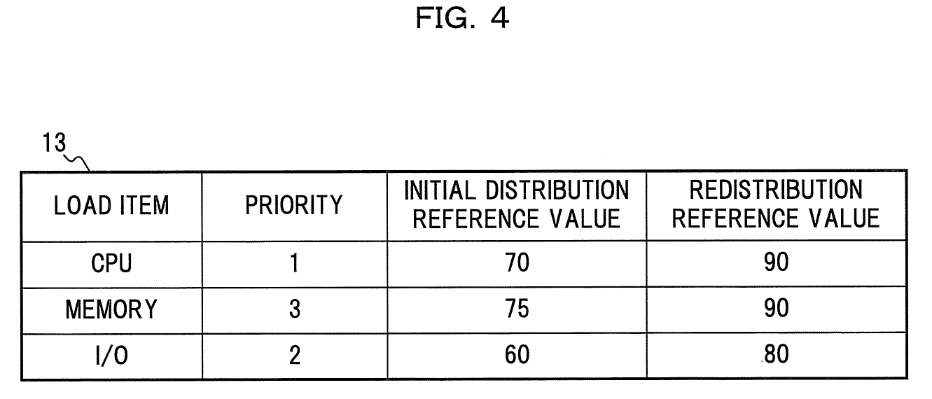

The distribution reference table 13 is a table for setting a distribution reference, which is a reference for performing an initial distribution and a redistribution (first and second or other subsequent distribution). As illustrated in FIG. 4, the distribution reference table 13 includes load item, priority, initial distribution reference value, and redistribution reference value.

Here, “priority” is a value indicating the load item among a plurality of load items in which the load status should be preferentially considered to determine whether a job is to be distributed. For example, in a case where the loads indicated by the load characteristics of a plurality of load items are the same, each process is performed on the basis of the load of a highest-priority load item. “Initial distribution reference value” is a threshold indicating the percentage (level) of the load of a server to which a job can be distributed, and values corresponding to the respective load items are set. On the other hand, “redistribution reference value” is a threshold indicating the percentage (level) of load for which a job that is being executed in a server needs to be redistributed to another server, and values corresponding to the respective load items are set.

The priority, initial distribution reference value, and redistribution reference value can be arbitrarily changed depending on an operation of the system. For example, in FIG. 4, the following three references are defined as distribution references: “load item: CPU, initial distribution reference value: 70%, redistribution reference value: 90%”; “load item: memory, initial distribution reference value: 75%, redistribution reference value: 90%”; and “load item: I/O, initial distribution reference value: 60%, redistribution reference value: 80%”. Priorities are set on the CPU, I/O, and memory in descending order.

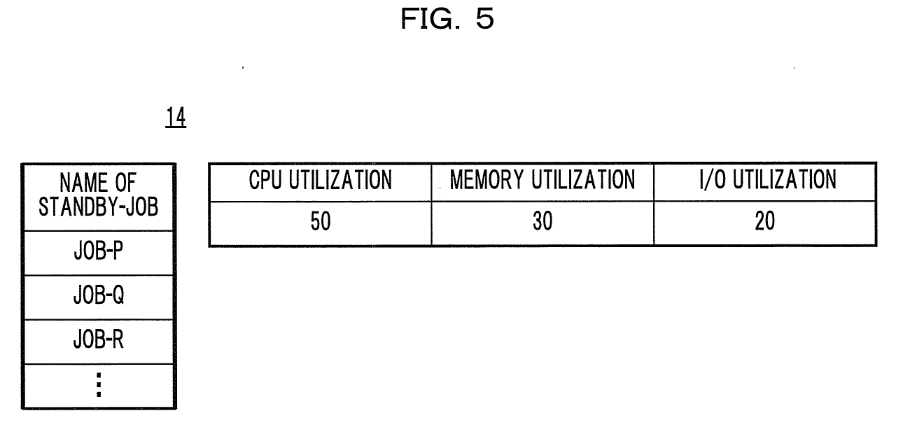

The standby-job table 14 is a table for temporarily queuing execution requests of jobs in a standby state in an overload state, and includes the name of standby job, as illustrated in FIG. 5. Also, the standby-job table 14 includes load statuses of respective load items (CPU utilization, memory utilization, and I/O utilization) serving as a standby cancel condition that is applied to all standby jobs.

The data stored in the foregoing tables may be held in the form of a text file, for example, instead of the form of table data. Further, while particular items are illustrated in exemplary tables, the present invention is not limited thereto.

The distribution control unit 15 specifies appropriate servers serving as distribution targets of jobs by referring to the load statuses of the respective servers stored in the load status table 12, and transmits execution requests of the jobs. When a server that is about to require redistribution occurs, the distribution control unit 15 transmits an instruction to decrease the load of a server serving as a redistribution target. Furthermore, when a server that requires redistribution occurs, the distribution control unit 15 transmits an instruction to redistribute a job. Furthermore, when a job cannot be distributed due to an overload state of a server, the distribution control unit 15 stores an execution request of the job in the standby-job table 14. On the other hand, when there is a server the load of which satisfies the standby cancel condition, the distribution control unit 15 transmits the execution request of the job to the server. The distribution control unit 15 may correspond to an initial distribution function, an initial distribution unit, an adjustment function, an adjusting unit, a redistribution function, and a redistribution unit.

The load monitoring unit 16 stores load statuses transmitted from the servers 20A, 20B and 20C at predetermined time intervals in the load status table 12 in units of servers. Also, the load monitoring unit 16 updates the information in the load status table 12 every time it receives a latest load status. The load monitoring unit 16 may correspond to a load monitoring function and a load monitoring unit.

Next, configurations of the servers 20A, 20B and 20C will be described. Hereinafter, the server 20A will be described as an example, but the servers 20B and 20C have the same configuration.

The server 20A includes a job execution unit 21A, a load measurement unit 22A, and a job transfer unit 23A.

Upon receipt of an execution request of a job from the load balancing apparatus 10, the job execution unit 21A starts execution of the job. Specifically, the job execution unit 21A executes the job in the following manner. That is, the job execution unit 21A transmits, to an application for performing a batch process, execution information of each job step as an object. Then, after the application ends, an object containing execution information for starting the application of the next job step is transmitted from the application to the job execution unit 21A. On the basis of the execution information, the job execution unit 21A transmits execution information of the next job step as an object to the application. This process is repeated until all the job steps are completed.

The load measurement unit 22A obtains a load status of the own server using a device management mechanism or the like of an operating system at predetermined time intervals or at the timing when a load status notification is requested from the load balancing apparatus 10, and notifies the load balancing apparatus 10 of the load status.

The job transfer unit 23A performs the following process when receiving a job transfer instruction from the load balancing apparatus 10. That is, the job transfer unit 23A transfers an execution request of the job, together with an object attached with execution information of the next job step, to another server specified by the load balancing apparatus 10 at the timing when execution of a job step currently being processed is completed.

Next, processes executed by the load balancing apparatus 10 will be described.

The load balancing apparatus 10 determines the stage of load in each of the servers 20A, 208 and 20C using the following reference and performs processes in accordance with the respective stages.

First stage:load<initial distribution reference value

In the first stage, the loads of the CPU, memory, and I/O serving as the load items are lower than the initial distribution reference value defined in the distribution reference table 13 in all the servers 20A, 20B and 20C.

Second stage:initial distribution reference value load<redistribution reference value, with allowance

In the second stage, the load of any of the servers 20A, 20B and 20C is equal to or higher than the initial distribution reference value defined in the distribution reference table 13 but is lower than the redistribution reference value, and there is an allowance with respect to the redistribution reference value. Here, a state with an allowance refers to a state where the load of a server is lower than an intermediate reference value, which is a predetermined value between the initial distribution reference value and the redistribution reference value. For example, in a case where the intermediate reference value is calculated using an expression “initial distribution reference value+(redistribution reference value−initial distribution reference value)÷2”, a state with an allowance means a state where a current load is lower than 50% with respect to the difference between the redistribution reference value and the initial distribution reference value. This state can be expressed by the following expression.

“load<initial distribution reference value+(redistribution reference value−initial distribution reference value)÷2”

In a case where there is a server the load of which has reached the second stage, the load balancing apparatus 10 performs control so that the load of the server does not increase from the current state. Specifically, the load balancing apparatus 10 specifies a load item having a high load characteristic among load items of the job associated with the execution request, and when there is a server the load of which has reached the second stage in the load item, the load balancing apparatus 10 performs control so that the job associated with the execution request is not distributed to the server.

Third stage:initial distribution reference value≦load<redistribution reference value, without allowance

In the third stage, the load of any of the servers 20A, 20B and 20C is equal to or higher than the initial distribution reference value defined in the distribution reference table 13 but is lower than the redistribution reference value, and there is no allowance with respect to the redistribution reference value. Here, a state without an allowance refers to a state where the load of a server is equal to or higher than the intermediate reference value. For example, in a case where the intermediate reference value is calculated using the same expression as that used in the second stage, a state without an allowance refers to a state where a current load is equal to or higher than 50% with respect to the difference between the redistribution reference value and the initial distribution reference value. This state can be expressed by the following expression.

“initial distribution reference value+(redistribution reference value−initial distribution reference value)÷2≦load”

A server the load of which has reached the third stage does not require redistribution in the current state, but is highly likely to be brought into a state of requiring redistribution. Therefore, the load balancing apparatus 10 does not distribute a new job to the server, and furthermore decreases the load of another server in preparation for smoothly redistributing the job that is being executed in the server to the other server. Specifically, the load balancing apparatus 10 performs control to transfer (exchange) jobs among servers so as to generate a server the load of which is low in the load item that has reached the third stage.

Fourth stage:load≧redistribution reference value

In the fourth stage, the load of any of the servers 20A, 20B and 20C is equal to or higher than the redistribution reference value defined in the distribution reference table 13.

A server the load of which has reached the fourth stage causes a processing delay due to an overload state, and thus requires redistribution. Thus, the load balancing apparatus 10 performs control so that the server transfers a job to another server having a low load generated in the process in the third stage.

Normally, the loads of the servers 20A, 20B and 20C are not constant and increase/decrease to some extent. Thus, during monitoring of the load statuses performed at predetermined time intervals, the load balancing apparatus 10 determines that the individual servers 20A, 20B and 20C are in any of the stages when a condition of the load status corresponding to the stage is successively satisfied a predetermined number of times.

The time intervals at which a load status notification is made and the predetermined number of times for determining whether a load corresponds to any of the stages can be set in the load balancing apparatus 10 by a system administrator or the like, for example.

Now, processes executed by the distribution control unit 15 and the load monitoring unit 16 will be described.

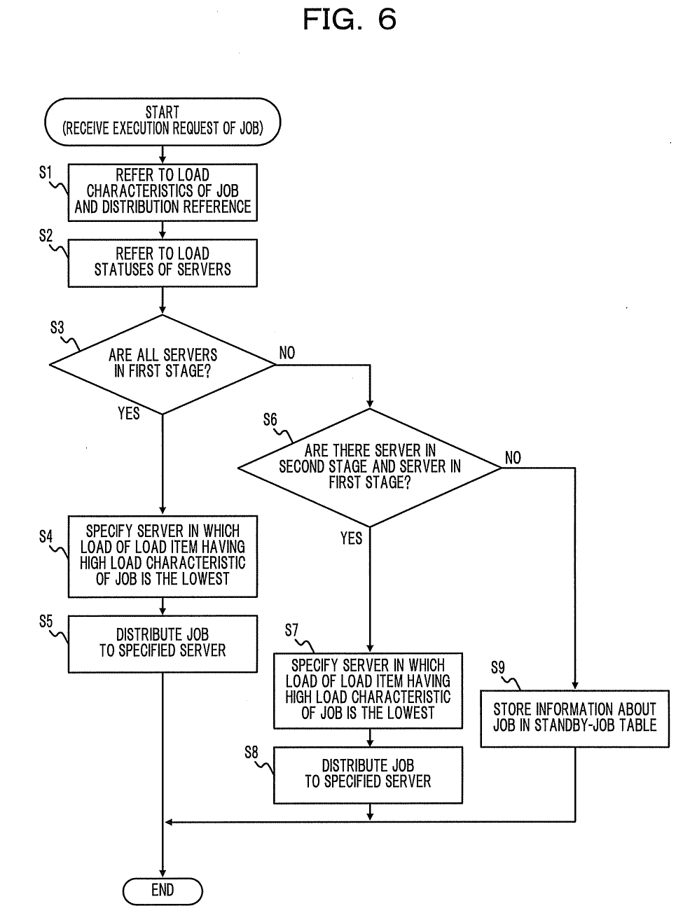

FIG. 6 illustrates a process executed by the distribution control unit 15 upon receipt of an execution request of a job. This process may correspond to process(es) performed as an initial distribution function and the initial distribution unit.

The distribution control unit 15 refers to load characteristics of the job attached to the execution request of the job, and also refers to the distribution reference in the distribution reference table 13 (S1). Also, the distribution control unit 15 refers to the load statuses of the servers 20A, 20B and 20C set in the load status table 12 (S2).

Then, the distribution control unit 15 determines whether the load of a load item having a high load characteristic of the job associated with the execution request is in the first stage in all the servers 20A, 20B and 20C (S3). If the load is in the first stage in all the servers 20A, 20B and 20C, the distribution control unit 15 specifies a server in which the load of the load item having a high load characteristic of the job associated with the execution request is the lowest on the basis of the load characteristics of the job associated with the execution request and the load statuses of the servers 20A, 20B and 20C (S4). In a case where there are a plurality of load items having a high load characteristic in the job, the process is performed by putting priority on a load item having the highest priority in the setting of the distribution reference (this is the same in the following). Then, the distribution control unit 15 transmits an execution request of the job to the specified server to distribute the job (S5). On the other hand, the job execution units 21A, 21B and 21C of the servers 20A, 20B and 20C that have received an execution request of a job start execution of the job.

If it is determined in S3 that the load is not in the first stage in all the servers 20A, 20B and 20C, that is, if there is a server the load of which has reached the second stage, the distribution control unit 15 performs the following determination. That is, the distribution control unit 15 determines whether there is a server in which the load of a load item having a high load characteristic of the job associated with the execution request has reached the second stage and whether there is a server in which the load of the load item is in the first stage (S6). In a case where those conditions are satisfied, the distribution control unit 15 specifies a server in which the load of a load item having a high load characteristic of the job associated with the execution request is the lowest among servers in the first stage (S7). Then, the distribution control unit 15 transmits the execution request of the job to the specified server to distribute the job (S8). On the other hand, the job execution units 21A, 21B and 21C of the servers 20A, 20B and 20C that have received an execution request of a job start execution of the job.

If the conditions in the determination made in S6 are not satisfied, information about the job associated with the execution request is stored in the standby-job table 14 (S9).

The job associated with the execution request stored in the standby-job table 14 is distributed to a server when there is the server that satisfies a standby cancel condition in a process of the distribution control unit 15 executed at predetermined time intervals (described below).

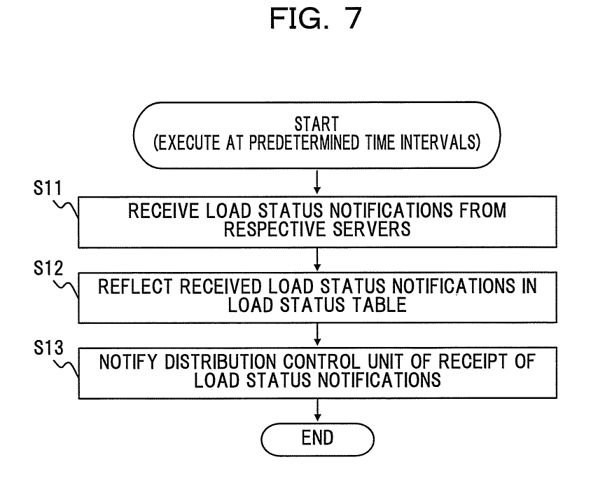

FIG. 7 illustrates a load monitoring process executed by the load monitoring unit 16 at predetermined time intervals. This process may correspond to a process performed by to the load monitoring function and the load monitoring unit.

The load monitoring unit 16 requests a load status notification to the servers 20A, 20B and 20C. On the other hand, each of the load measurement units 22A, 22B and 22C of the servers 20A, 20B and 20C that has received the request for a load status notification obtains a load status of the own server and transmits a load status notification to the load balancing apparatus 10. Alternatively, each server may transmit a load status notification at predetermined time intervals, not in response to a request from the load balancing apparatus 10. Accordingly, the load monitoring unit 16 receives load status notifications from the servers 20A, 20B and 20C (S11). Furthermore, the load monitoring unit 16 reflects the load statuses according to the received load status notifications in the load status table 12 (S12). Also, the load monitoring unit 16 notifies the distribution control unit 15 that the load status notifications have been received (S13).

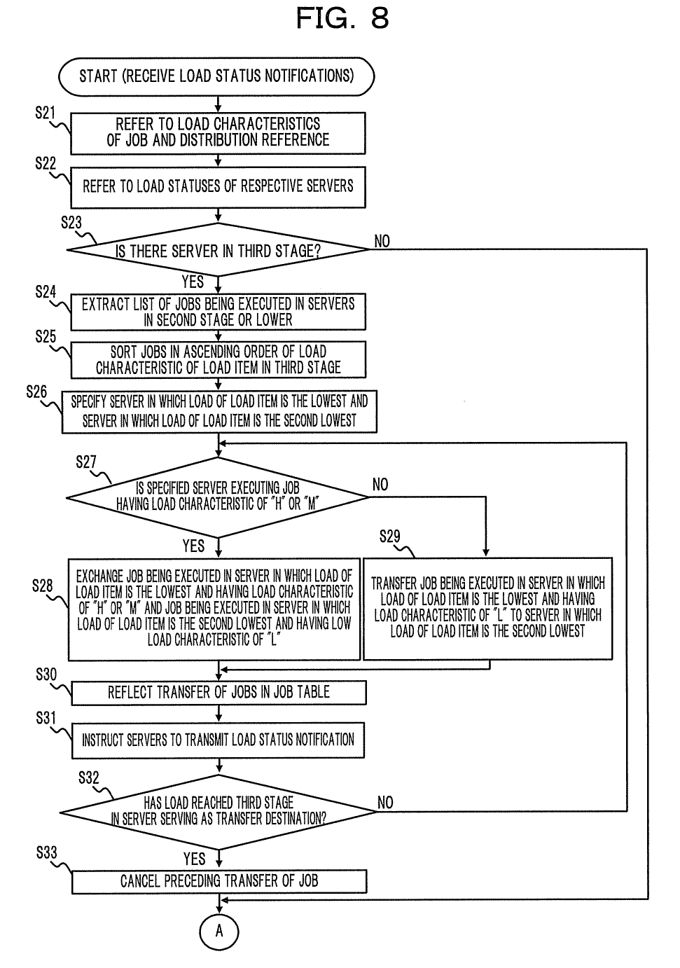

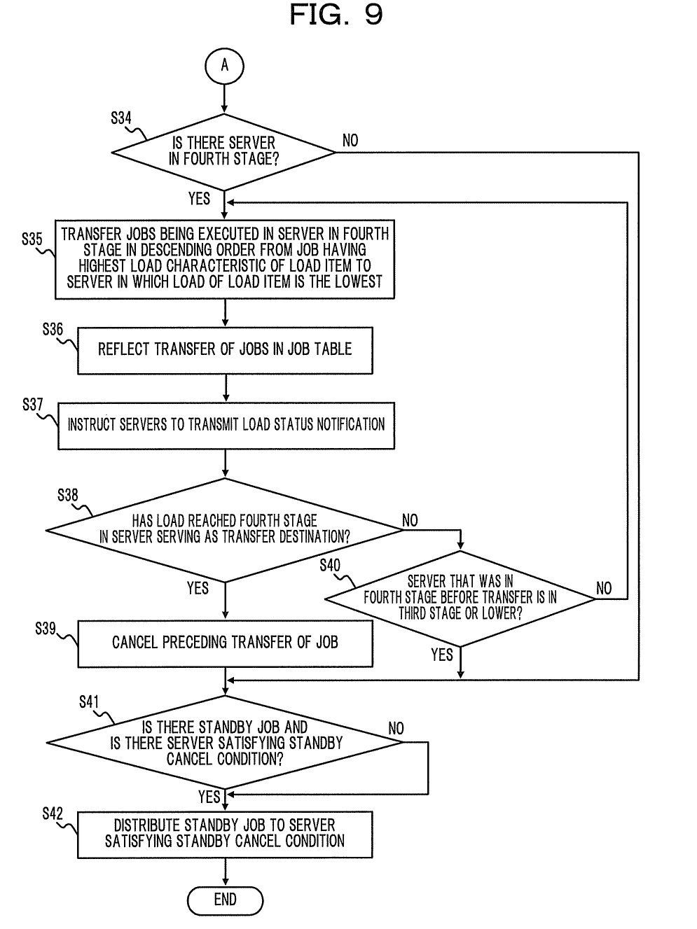

FIGS. 8 and 9 illustrate a process executed by the distribution control unit 15 when the distribution control unit 15 is notified from the load monitoring unit 16 at predetermined time intervals that load status notifications are received by the load monitoring unit 16 from the servers 20A, 20B and 20C. This process may correspond to process(es) performed by the adjustment function, the adjustment unit, the redistribution function, and the redistribution unit.

The distribution control unit 15 obtains load characteristics attached to an execution request of a job, while referring to the distribution reference (priorities of respective load items, initial distribution reference value, and redistribution reference value) set in the distribution reference table 13 (S21). Also, the distribution control unit 15 refers to the load statuses of the servers 20A, 20B and 20C stored in the load status table 12 (S22).

Here, the distribution control unit 15 determines whether there is a server in which the load of any of the load items has reached the third stage (S23). If there is a server in the third stage, the distribution control unit 15 extracts, from the job table 11, a list of jobs being executed in servers that are in a state where the load of the load item that has reached the third stage is in the second stage or lower (S24). Then, the distribution control unit 15 sorts the extracted jobs in ascending order of the load characteristic of the load item that has reached the third stage (S25).

Furthermore, the distribution control unit 15 specifies a server in which the load of the load item that has reached the third stage is the lowest and a server in which the load of the load item is the second lowest by referring to the load status table 12 (S26). Then, the distribution control unit 15 determines whether a job having a high load characteristic of the load item that has reached the third stage (a job having a load characteristic of “H” or “M”) is being executed in the server in which the load of the load item that has reached the third stage is the lowest (S27). If it is determined that the job is being executed, the distribution control unit 15 exchanges the job that is being executed in the server in which the load of the load item that has reached the third stage is the lowest and that has a high load characteristic of the load item and the job that is being executed in the server in which the load of the load item is the second lowest and that has a low load characteristic of the load item (job having a load characteristic of “L”) (S28). Specifically, the distribution control unit 15 transmits, to the server in which the load of the load item that has reached the third stage is the lowest, an instruction to transfer the job that is being executed in the server and that has a high load characteristic of the load item to the server in which the load of the load item is the second lowest. On the other hand, the distribution control unit 15 transmits, to the server in which the load of the load item that has reached the third stage is the second lowest, an instruction to transfer the job that is being executed in the server and that has a low load characteristic of the load item to the server in which the load of the load item is the lowest. Then, the job transfer unit of the server that has received the transfer instruction transfers the job to the server specified as a transfer destination (same in the following). On the other hand, if it is determined in S27 that a job having a high load characteristic of the load item that has reached the third stage is not being executed, the distribution control unit 15 transmits an instruction to transfer the job that is being executed in the server in which the load of the load item in the third stage is the lowest and that has a low load characteristic of the load item to the server in which the load of the load item is the second lowest (S29). Then, the distribution control unit 15 reflects transfer of the jobs in the job table 11 (S30). Specifically, the values of items of the execution servers corresponding to the jobs transferred among servers are updated to the values of the servers serving as transfer destinations.

Also, the distribution control unit 15 transmits, to the servers 20A, 20B and 20C, an instruction to transmit a load status notification (S31). Furthermore, as a result of performing transfer of the jobs, the distribution control unit 15 determines whether the load has reached the third stage in the server serving as a transfer destination (S32). If the load has reached the third stage in the server serving as the transfer destination, the distribution control unit 15 cancels the preceding transfer of the job (S33). On the other hand, if the load has not reached the third stage in the server serving as the transfer destination, the distribution control unit 15 returns to step S27 and performs transfer of another job.

Subsequently, the distribution control unit 15 determines whether there is a server in which the load of any of the load items has reached the fourth stage (S34) as shown in FIG. 9. If such a server exists, the distribution control unit 15 transfers, to the server in which the load of the load item is the lowest, the jobs being executed in the server in descending order from the job having the highest load characteristic of the load item that has reached the fourth stage (S35). Then, the distribution control unit 15 reflects the transfer of the jobs in the job table 11 (S36).

Then, the distribution control unit 15 transmits, to the servers 20A, 20B and 20C, an instruction to transmit a load status notification (S37). Furthermore, as a result of performing transfer of the jobs, the distribution control unit 15 determines whether the load has reached the fourth stage in the server serving as a transfer destination (S38). If the load has reached the fourth stage in the server serving as the transfer destination, the distribution control unit 15 cancels the preceding transfer of the job (S39). On the other hand, if it is determined in S38 that the load has not reached the fourth stage in the server serving as the transfer destination, the distribution control unit 15 further determines whether the load of the server that was in the fourth stage before transfer of a job (the server that has transferred a job to another server) is in the third stage or lower (S40). If the load of the server is in the third stage or lower, the process ends. On the other hand, if the load is not in the third stage or lower, the process returns to S35, where the distribution control unit 15 transfers another job.

Also, the distribution control unit 15 determines whether there is a standby job and refers to a standby cancel condition by referring to the standby-job table 14. On the other hand, the distribution control unit 15 obtains the load statuses of the respective servers by referring to the load status table 12. When there is a standby job and when there is a server that satisfies the standby cancel condition (S41), the distribution control unit 15 distributes the standby job to the server that satisfies the standby cancel condition (S42). Otherwise, the process ends.

Additionally, in the servers 20A, 20B and 20C that have received an instruction to transfer (exchange) a job from the load balancing apparatus 10 in the above-described process, the job transfer units 23A, 23B and 23C perform transfer of jobs among the servers. Transfer of jobs can be performed directly among the servers 20A, 20B and 20C or via the load balancing apparatus 10.

Now, the process performed in the load balancing apparatus 10 will be further described using a specific example.

First, a description will be given about a process that is performed in a case where the loads of the load items are in the first stage in all the servers 20A, 20B and 20C when an execution request of a job is received.

In this specific example, assume a case where an execution request of job X (the value in each table is “JOB-X”, same for the others) is newly issued. The load characteristics of job X are as follows, CPU load characteristic: H, memory load characteristic: L, and I/O load characteristic: L.

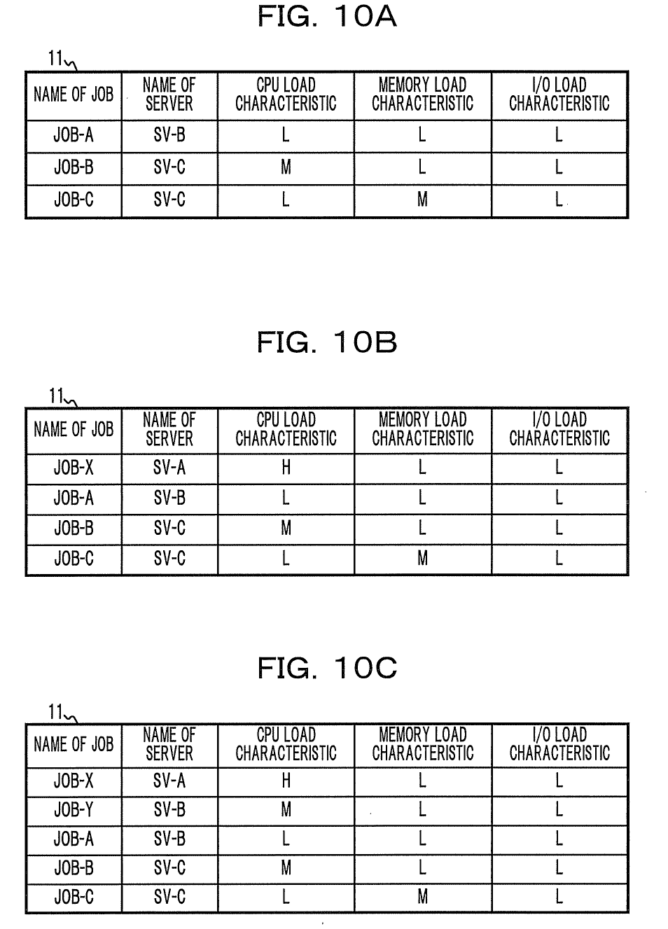

At this time, jobs are being executed in the servers 20A, 20B and 20C in the manner illustrated in FIG. 10A. That is, no job is being executed in the server 20A (the value in each table is “SV-A”, same for the others), job A (CPU load characteristic: L, memory load characteristic: L, I/O load characteristic: L) is being executed in the server 20B, and job B (CPU load characteristic: M, memory load characteristic: L, I/O load characteristic: L) and job C (CPU load characteristic: L, memory load characteristic: M, I/O load characteristic: L) are being executed in the server 20C.

In this specific example, a distribution reference is set in the distribution reference table 13 illustrated in FIG. 4. That is, the initial distribution reference values of the respective load items are as follows: 70% for the CPU; 75% for the memory; and 60% for the I/O.

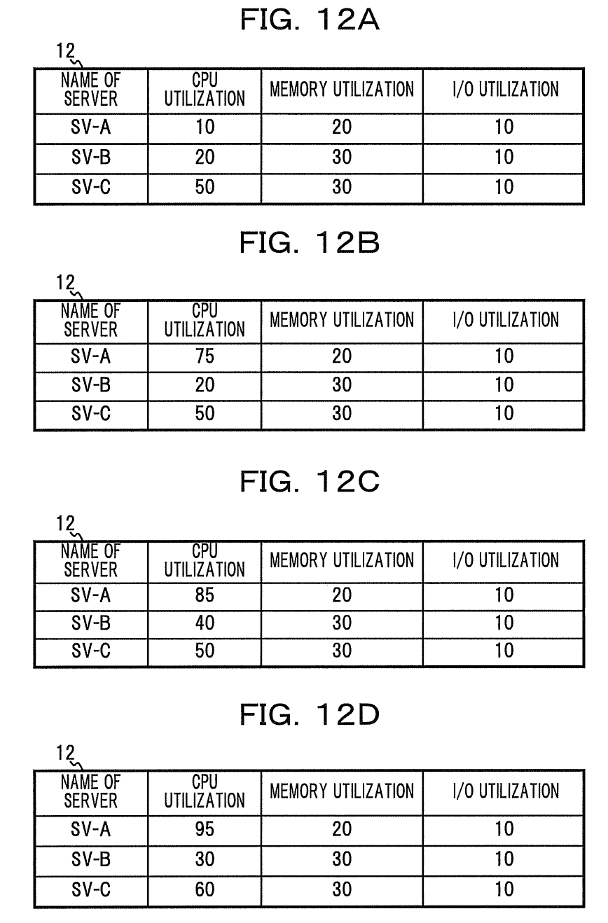

On the other hand, the load statuses of the servers 20A, 20B and 20C are illustrated in FIG. 12A. In every server, the loads (utilizations) of all the load items are lower than the initial distribution reference values. Therefore, the distribution control unit 15 determines the stage to be the first stage.

Here, regarding the load characteristics of job X, the load characteristic of the CPU is the highest of “H”. Also, according to the load status table 12, the load of CPU is the lowest in the server 20A.

Thus, the distribution control unit 15 distributes job X to the server 20A. As a result, the execution statuses of the jobs illustrated in FIG. 10B are obtained.

In this process, job X in which the load characteristic of the CPU is high is distributed to the server in which the load of the CPU is the lowest among the servers 20A, 20B and 20C. Accordingly, a high load in a specific server can be prevented, and load balancing among the servers can be realized.

Next, a description will be given about a process performed in a case where an execution request of a job is further received in the above-described specific example and where there is a server having a load item in which the load has reached the second stage.

In this specific example, assume a case where an execution request of job Y is newly issued. The load characteristics of job Y are as follows, CPU load characteristic: M, memory load characteristic: L, and I/O load characteristic: L.

At this time, jobs are being executed in the servers 20A, 20B and 20C in the manner illustrated in FIG. 10B.

Also, as described above, the distribution reference is set in the distribution reference table 13 illustrated in FIG. 4. The initial distribution reference values of the respective load items are as follows: 70% for the CPU; 75% for the memory; and 60% for the I/O. On the other hand, the redistribution reference values are as follows: 90% for the CPU; 90% for the memory; and 80% for the I/O. At this time, intermediate reference values calculated using the expression “initial distribution reference value+(redistribution reference value−initial distribution reference value)÷2” are as follows: 80% for the CPU; 82.5% for the memory; and 70% for the I/O.

The load statuses of the respective servers are illustrated in FIG. 12B. That is, the load (utilization) of the CPU of the serer 20A is 75%, which is higher than the initial distribution reference value of 70% and which is lower than the intermediate reference value of 80%. Thus, the distribution control unit 15 determines that the CPU of the server 20A is in the second stage.

Also, according to the load status table 12, it can be understood that the server 20B is in the first stage and that the load of the CPU of the server 20B is the lowest.

Therefore, the distribution control unit 15 distributes job Y to the server 20B. As a result, the execution statuses of the jobs illustrated in FIG. 10C are obtained.

According to this process, it can be prevented that job Y having a high load characteristic of the CPU is distributed to the server 20A in which the load of the CPU is increasing. Thus, the occurrence of a server having a high load and a necessity of redistribution can be prevented.

Furthermore, a description will be given about a process performed in a case where there is a server having a load item in which the load has reached the third stage when load status notifications are transmitted from the servers 20A, 20B and 20C at predetermined time intervals in the above-described specific example.

At this time, jobs are being executed in the servers 20A, 20B and 20C in the manner illustrated in FIG. 10C.

The load statuses of the servers 20A, 20B and 20C are illustrated in FIG. 12C. That is, the load of the CPU of the server 20A is 85% due to various factors, which is higher than the initial distribution reference value of 70% and the intermediate reference value of 80% and is lower than the redistribution reference value of 90%. Thus, the distribution control unit 15 determines that the load of the CPU of the server 20A is in the third stage.

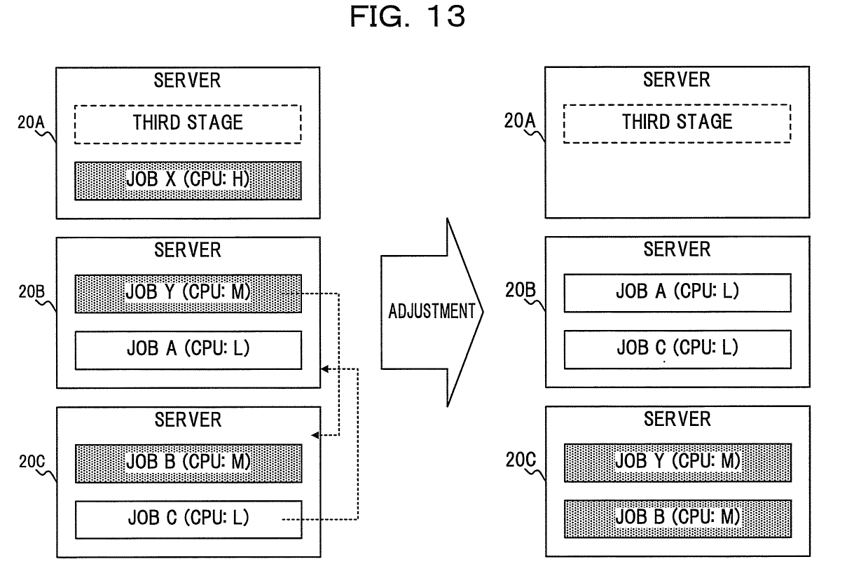

In the current load status, the load of the CPU of the server 20B is 40%, which is the lowest. Thus, the distribution control unit 15 performs the following control to further decrease the load of the CPU of the server 20B, in which the load of the CPU is low, in preparation for a state where the load of the CPU of the server 20A reaches the fourth stage and where redistribution is necessary. That is, the distribution control unit 15 causes the server 20B to transfer job Y, in which the load characteristic of the CPU is “M”, among the jobs being executed in the server 20B to the server 20C, and also causes the server 20C to transfer job C, in which the usage frequency of the CPU is “L”, among the jobs being executed in the server 20C to the server 20B. In addition, FIG. 13 illustrates transfer of jobs in the third stage.

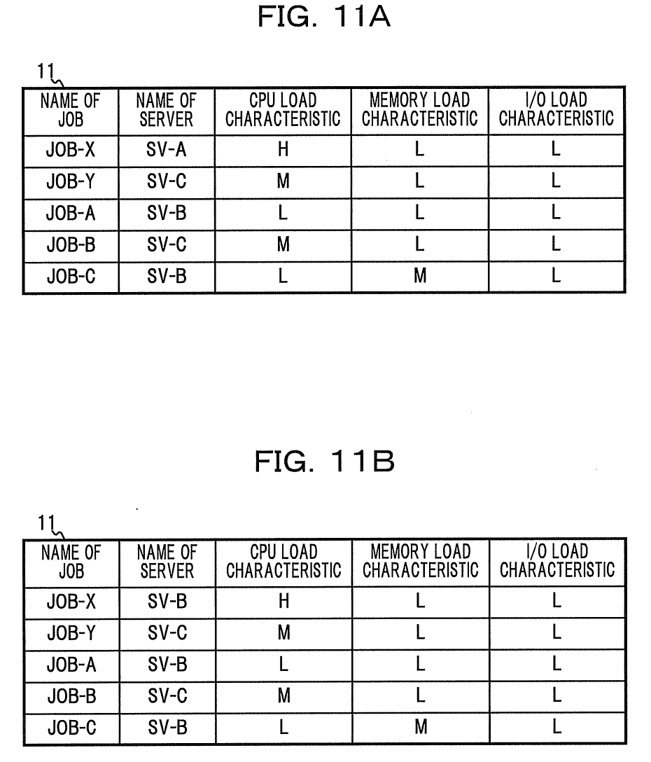

As a result, the execution statues of jobs illustrated in FIG. 11A are obtained.

According to this process, the load of the CPU of the server 20B, in which the load of the CPU is originally low, is further decreased, whereby preparation for accepting a job having a high load characteristic of the CPU can be made in the server 20B. Therefore, even if a job being executed in the server 20A is transferred to the server 20B when the load of the CPU of the server 20A reaches the fourth stage and when redistribution is necessary, risk of too high load of the CPU of the server 20B serving as a transfer destination can be reduced.

Next, a description will be given about a process performed in a case where the load of the CPU of the server 20A is in the fourth stage as a result of notification of a load status after a job has been transferred in a process in the third stage.

At this time, jobs are being executed in the servers in the manner illustrated in FIG. 11A.

The load statuses of the respective servers are illustrated in FIG. 12D. That is, the load of the CPU of the server 20A is higher at 95%, which is higher than the redistribution reference value of 90%. Thus, the distribution control unit 15 determines that the load of the CPU of the server 20A is in the fourth stage.

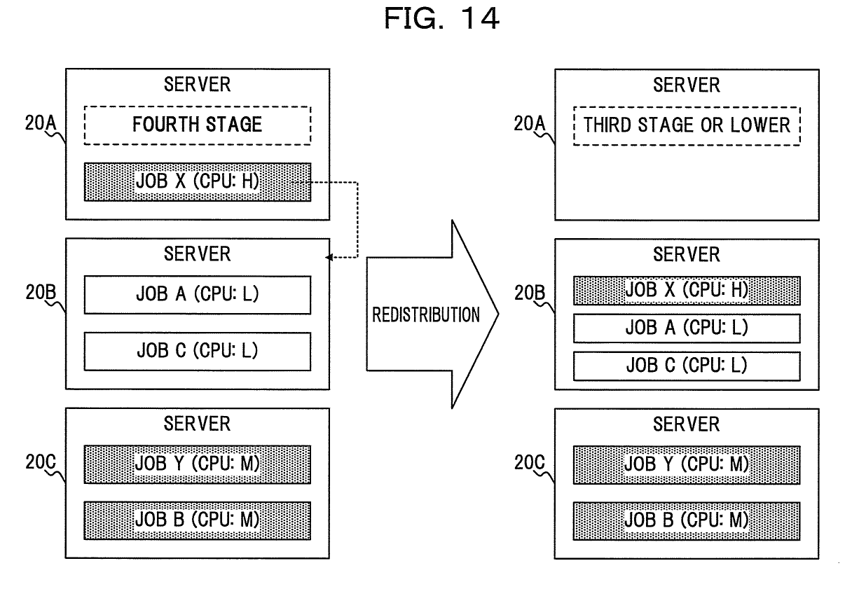

Also, as a result of transfer of a job in the above-described process in the third stage, the load of the CPU of the server 20B is lower. Thus, the load balancing apparatus 10 performs the following process to decrease the load of the CPU of the server 20A that has reached the fourth stage. That is, job X that is being executed in the server 20A and that has a high load characteristic of the CPU is transferred to the server 20B. FIG. 14 illustrates transfer of the job in this specific example.

As a result, the execution statuses of the jobs illustrated in FIG. 11B are obtained.

According to this process, job X having a high load characteristic of the CPU is redistributed to the server 20B from the server 20A in which the load of the CPU has increased, whereby the load of the server 20A can be decreased. On the other hand, in the server 20B serving as a transfer destination of the job, the load of the CPU has been decreased in the process in the third stage, which increases the possibility that the redistribution is successfully performed.

As described above, in the load balancing apparatus 10, an overload state in individual servers is prevented in accordance with the stage of the load that is determined on the basis of a certain reference (initial distribution reference value, intermediate reference value, and redistribution reference value). Thus, various advantages are reliably realized including: the occurrence of a server requiring redistribution is prevented as much as possible; and redistribution is smoothly performed even when redistribution is required. Accordingly, a stable operation of individual servers is realized, and an execution delay of a batch process due to an overload state of a server can be prevented in the whole system.

Specifically, the load balancing apparatus 10 prevents distributing a new job to a server the load of which is higher than the initial distribution reference value at the initial distribution (the second stage). Accordingly, the occurrence of a server requiring redistribution can be prevented. Also, at this time, the load balancing apparatus 10 distributes a job to a server having the lowest load at the time of distribution. Therefore, load balancing is appropriately performed in the whole system, and concentration of loads can be prevented. Furthermore, the load balancing apparatus 10 distributes a job to a server having a low load of a load item in which a load characteristic of the job is high in view of the load characteristic of the job associated with an execution request. Accordingly, more precise and appropriate load balancing is realized.

Also, in the load balancing apparatus 10, the following process is performed in monitoring of load statuses performed at predetermined time intervals. That is, in the load balancing apparatus 10, when there is a server that has a load higher than the initial distribution reference value and that is highly possible to reach a stage requiring redistribution (third stage), a server having a low load is prepared as a redistribution target for redistribution. Therefore, a state where there is no server serving as a redistribution target when redistribution is necessary can be prevented, and risk of an overload state in a server serving as a redistribution target can be reduced. Also, at this time, at least a job being executed in a server serving as a redistribution target is transferred to another server, whereby the load of the server serving as the redistribution target can be reliably decreased. Furthermore, in the load balancing apparatus 10, it is determined which load item has a high load in a server that is highly possible to reach a stage requiring redistribution, and control is performed to particularly reduce the load of the load item in a server serving as a redistribution target. Accordingly, the success rate of redistribution can be further increased.

In the above-described process, when there is a server that has reached the third stage and when a job having a high load characteristic is being executed in a server having a lowest load, the job having a high load characteristic and a job having a low load characteristic are exchanged between the server having a lowest load and a server having a second lowest load. Alternatively, a job may be merely transferred from the server having a lowest load to the server having a second lowest load. In this case, risk of increase in load in the server serving as a transfer destination increases, but the load of the server having the lowest load can be further reduced.

Also, the range of load in the second stage where a new job is not distributed and the range of load in the third stage where preparation for redistribution is performed may be arbitrarily changed in accordance with an operation form of the system. For example, stepwise load balancing can be realized in the load balancing apparatus 10 even if the ranges of the second and third stages are partly or totally overlapped. For example, the upper limit of the range of the load in the second stage may be increased to realize a state where a current load is 80% or less with respect to the difference between the redistribution reference value and the initial distribution reference value. In this case, a server in an overload state is more likely to occur compared to a case of 50% or less, but the system can be operated by reducing standby jobs. On the other hand, the lower limit of the range of the load in the third stage may be decreased to realize a state where a current load is 30% or less with respect to the difference between the redistribution reference value and the initial distribution reference value. In this case, a server serving as a redistribution target can be prepared in a stage where there is an allowance with respect to the redistribution reference value of the load of a server during monitoring of load statuses, which can be a preparation for a sudden increase in load of a server in a short time.

According to an embodiment, a method of load balancing is provided. The method of an embodiment includes monitoring load statuses of servers subsequent to a distribution of jobs of a batch process to one of the servers and adjusting a value used to specify a redistribution target subsequent to the distribution of the jobs based on the monitoring that is continuously implemented until completion of the batch process.

In addition, basically, this system can operate and the above-described effects can be obtained even when “or less (e.g., load≦redistribution reference value)” is replaced by “lower than (e.g., load<redistribution reference value)” in the description given above, and vice versa. This is the same in the combination of “or more” and “higher than”.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

Further, according to an aspect of the embodiments, any combinations of the described features, functions and/or operations can be provided.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention, the scope of which is defined in the claims and their equivalents.

What is claimed is:

1. A computer-readable recording medium having a load balancing program recorded thereon, the load balancing program causing a computer to execute an operation, comprising:
monitoring load statuses of a plurality of servers, which are connected with a network, at a predetermined time interval;
initially distributing, jobs of a batch process associated with an execution request only to one or more of the plurality of servers having a load lower than an initial distribution reference value, which indicates a level of load for which distribution of a job is allowed, based on said monitoring;
adjusting distribution of the jobs, in a case where a load of any one of the plurality of servers is higher than at least the initial distribution reference value and is lower than a redistribution reference value, which indicates a level of load for which a job being executed in a server is necessary to be redistributed to another server, based on said monitoring, said adjusting being with respect to a server having a lowest load among the plurality of servers except the one of the plurality of servers, the server serving as a redistribution target of a job and the adjusting being so that the load of the server serving as the redistribution target decreases to lower than a current load; and
redistributing a job being executed in the one of the plurality of servers to another server in a case where a load of any one of the plurality of servers is higher than the redistribution reference value based on said monitoring.

2. The recording medium according to claim 1, wherein the adjusting occurs, only when a load of any one of the plurality of servers is higher than an intermediate reference value, which is a predetermined value between the initial distribution reference value and the redistribution reference value, and with respect to a server having a lowest load among the plurality of servers except the one of the plurality of servers, the specified server serving as the redistribution target of a job, and
the adjusting of the distribution of the jobs occurs with the other servers so that the load of the server serving as the redistribution target decreases to lower than a current load.

3. The recording medium according to claim 1, wherein the adjusting transmits to the server serving as the redistribution target, an instruction to transfer at least a job being executed in the server serving as the redistribution target to another server.

4. The recording medium according to claim 1, wherein the initial distributing causes a job associated with the execution request to be a standby job when a load of any one of the plurality of servers is higher than an intermediate reference value, which is a predetermined value between the initial distribution reference value and the redistribution reference value, and the redistributing, when a load of any one of the plurality of servers satisfies a standby cancel condition allowing distribution of the standby job to a server, the standby job to the server satisfying the standby cancel condition.

5. The recording medium according to claim 1, wherein each of the jobs has load characteristics serving as indexes indicating levels of loads of individual load items serving as load factors of a server in processing the job,
wherein the monitoring monitors the load statuses of the plurality of servers in units of load items,
wherein the initial distributing distributes a job associated with the execution request to a server in which a load of a load item having a high load characteristic of the job associated with the execution request is lower than the initial distribution reference value corresponding to the load item among the plurality of servers,
wherein the adjusting, in a case where a load of any one of the load items is higher than at least the initial distribution reference value corresponding to the one of the load items and is lower than the redistribution reference value corresponding to the one of the load items in any one of the plurality of servers, a server having a lowest load of the one of the load items among the plurality of servers except the one of the plurality of servers, the specified server serving as a redistribution target of a job, thereby adjusting distribution of the jobs with the other servers so that the load of the one of the load items in the server serving as the redistribution target decreases to lower than a current load, and
wherein the redistributing, in a case where a load of any one of the load items is higher than the redistribution reference value corresponding to the one of the load items in any one of the plurality of servers, a job being executed in the one of the plurality of servers to another server.

6. The recording medium according to claim 5, wherein priorities of the load items are preset for the load items, and
wherein, in a case where there are a plurality of load items in which levels of loads indicated by the load characteristics of the job to be processed are the same, each of the initial distributing, the adjusting, and the redistributing performs a process based on the load of a highest-priority load item among the plurality of load items.

7. The recording medium according to claim 2, wherein the intermediate reference value is a value that is obtained by adding the initial distribution reference value and a value of substantially 50% of a difference between the initial distribution reference value and the redistribution reference value.

8. The recording medium according to claim 1, wherein the adjusting specifies the server serving as the redistribution target, specifies a server having a lowest load next to the load of the server serving as the redistribution target,
the adjusting transmits, to the server serving as the redistribution target, an instruction to transfer a job being executed in the server serving as the redistribution target to the server having the lowest load next to the load of the server serving as the redistribution target, and
the adjusting transmits, to the server having the lowest load next to the load of the server serving as the redistribution target, an instruction to transfer, to the server serving as the redistribution target, a job having a load lower than the load of the job to be transferred from the server serving as the redistribution target among jobs being executed in the server having the lowest load next to the load of the server serving as the redistribution target.

9. A load balancing apparatus, comprising:
a load monitoring unit configured to monitor load statuses of a plurality of servers, which are connected with a network, at predetermined time intervals;
an initial distribution unit configured to distribute, upon receipt of an execution request of jobs of a batch process, jobs associated with the execution request only to one or more of the plurality of servers having a load lower than an initial distribution reference value, which indicates a level of load for which distribution of a job is allowed, based on the load statuses of the plurality of servers monitored;
an adjustment unit configured to specify, in a case where a load of any one of the plurality of servers is higher than at least the initial distribution reference value and is lower than a redistribution reference value, which indicates a level of load for which a job being executed in a server is necessary to be redistributed to another server, when the load statuses are monitored, a server having a lowest load among the plurality of servers except the one of the plurality of servers, the specified server serving as a redistribution target of a job, thereby adjusting distribution of the jobs so that the load of the server serving as the redistribution target decreases to lower than a current load; and
a redistribution unit configured to redistribute, in a case where a load of any one of the plurality of servers is higher than the redistribution reference value when the load statuses are monitored, a job being executed in the one of the plurality of servers to another server.

10. A load balancing method for servers, said load balancing method comprising:
allocating a job to one or more servers having a load lower than a first reference value, respectively;
reducing a load of a second server having a lowest load among said servers by a load balancing upon detection of a first server having a load that is higher than said first reference value and is lower than a second reference value; and
reallocating a job of said any server to another server having the lowest load among said servers upon detection of any server having a load that is higher than said second reference value.

11. A method of load balancing, comprising:
monitoring load statuses of servers subsequent to a distribution of jobs of a batch process to one of said servers; and
adjusting a value used to specify a redistribution target subsequent to the distribution of the jobs based on said monitoring that is continuously implemented until completion of the batch process.

12. The method according to claim 11, wherein the value used to specify the redistribution target is set incrementally.
